(19) United States
(12) Patent Application Publication
(10) Pub. No.: US 2003/0226473 A1
(43) Pub. Date: Dec. 11, 2003

(54) Ink set having broad-range dark part color reproduction ability, and recording method and recorded article

(75) Inventor: Bunji Ishimoto, Nagano (JP)

Correspondence Address: LADAS & PARRY, 26 WEST 61ST STREET, NEW YORK, NY, 10023, US

(73) Assignee: SEIKO EPSON CORPORATION

(21) Appl. No.: 10/369,342

(22) Filed: Feb. 18, 2003

(30) Foreign Application Priority Data
Feb. 18, 2002 (JP) 2002-040850

(51) Int. Cl. C09D 11/00; G01D 11/00

(52) U.S. Cl. 106/31.6; 106/31.9; 106/31.86; 347/100; 428/32.1

(57) ABSTRACT

It is an object of the present invention to provide an ink set for which color differences of a recorded image due to differences in light source can be made to be slight, and the color reproduction range in dark parts of an image can be broadened, while maintaining high image quality with no worsening of the graininess in the dark parts. With the present invention, the above object is attained by providing an ink set that comprises at least a black ink composition containing a black pigment, and a light black ink composition containing the black pigment at a concentration less than the pigment concentration in the black ink composition, wherein the ratio of the pigment concentration in the black ink composition to the pigment concentration in the light black ink composition is in a range of 2 to 4.5.

### BACKGROUND OF THE INVENTION

1. Field of the Invention

The present invention relates to an ink set for which color differences of a recorded image due to differences in light source are slight, high image quality is maintained with no worsening of graininess in dark parts of an images and the color reproduction range in the dark parts is broadened.

2. Description of the Related Art

Conventionally, various ink sets each comprising a plurality of ink compositions have been used for recording printed images having high image quality. In particular, to improve color reproduction ability in dark parts of a printed image, a 4-color ink set comprising a cyan ink composition, a magenta ink composition, and a yellow ink composition, along with a black ink composition, or a 6-color ink set comprising a cyan ink composition, a light cyan ink composition having a cyan pigment concentration lower than that of the cyan ink composition, a magenta ink composition, a light magenta ink composition having a magenta pigment concentration lower than that of the magenta ink composition, and a yellow ink composition, along with a black ink composition, or the like is used.

However, with such a conventional ink set, a tendency for the graininess to worsen in dark parts of a printed recorded image is seen. Various means of suppressing the graininess have thus been tried out, but there is a problem that if one attempts to suppress the graininess, then the color reproduction range in the dark parts becomes narrow.

Moreover, for some ink sets, there has been a problem that in the case of different light sources such as sunlight and a fluorescent lamp, the color difference due to the choice of differences in light sources may be large.

### SUMMARY OF THE INVENTION

It is thus an object of the present invention to provide an ink set for which color differences of a recorded image due to differences in light source can be made to be slight, and the color reproduction range in dark parts of an image can be broadened, while maintaining high image quality with no worsening of the graininess in the dark parts.

The present inventors carried out assiduous studies, and as a result discovered that the above object can be attained by an ink set that comprises two types of black ink composition having different black pigment concentrations to one another, wherein the pigment concentration ratio between these black ink compositions is made to be in a prescribed range.

The present invention was accomplished based on the above discovery; the above object is attained by providing an ink set that comprises at least a black ink composition containing a black pigment, and a light black ink composition containing the black pigment at a concentration less than the pigment concentration in the black ink composition, wherein the ratio of the pigment concentration in the black ink composition to the pigment concentration in the light black ink composition is in a range of 2 to 4.5.

Moreover, the present invention provides a recording method that comprises the step of forming an image on a recording medium using the above-mentioned ink set.

Moreover, the present invention provides a recorded article that comprises a recording medium having an image formed thereon using the above-mentioned ink set.

### DESCRIPTION OF THE PREFERRED EMBODIMENTS

Following is a detailed description of the present invention based on preferred embodiments thereof.

(Ink set)

The ink set of the present invention comprises at least a black ink composition containing a black pigment, and a light black ink composition containing the black pigment at a concentration less than the pigment concentration in the black ink composition, wherein the ratio of the pigment concentration in the black ink composition to the pigment concentration in the light black ink composition is in a range of 2 to 4.5.

With the present invention, due to the ratio of the pigment concentration in the black ink composition to the pigment concentration in the light black ink composition out of the ink compositions in the ink set being in a range of 2 to 4.5 as described above, the color reproduction range in dark parts of a recorded image formed by printing can be broadened, and at this time there is no worsening of the graininess (a state in which dots of discharged ink can be visually identified in the recorded image) in the dark parts of the image, and hence an image having high image quality can be obtained. Moreover, according to the ink set of the present invention for which the black pigment concentration ratio is in the above range, images can be formed for which color differences due to differences in light source are slight.

The black ink composition and the light black ink composition in the ink set of the present invention each contain at least a black pigment. A preferable example of the black pigment is carbon black (C.I. Pigment Black 7), for example furnace black, lamp black, acetylene black or channel black. More specifically, No. 2300 No. 2200B, No. 900, MCF88, No. 33, No. 40, No. 45, No. 52, MA7, MA8, MA100 and so on made by Mitsubishi Chemical Corporation, Raven 5750, Raven 5250, Raven 5000, Raven 3500, Raven 1080, Raven 1255, Raven 700 and so on made by Columbian Chemicals Company, Regal 400R, Regal 330R, Regal 660R, Mogul L, Monarch 700, Monarch 800, Monarch 880, Monarch 900, Monarch 1000, Monarch 1100, Monarch 1300, Monarch 1400 and so on made by Cabot Corporation, and Color Black FW1, Color Black FW2, color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, Special Black 4 and so on made by Degussa can be used.

The content of the black pigment in the black ink composition is preferably in a range of 0.1 to 20 wt %, more preferably 1 to 10 wt %, of the black ink composition. On the other hand, the content of the black pigment in the light black ink composition is preferably in a range of 0.025 to 10 wt %, more preferably 0.25 to 5wt %, of the light black ink composition. Use of the black pigment is adjusted within these content ranges such that the ratio of the pigment concentration in the black ink composition to the pigment concentration in the light black ink composition is in a range of 2 to 4.5.

Apart from the pigment concentration differing, the black ink composition and the light black ink composition used in the present invention have-basically the same composition as one another. A description will be given later of components other than the black pigment in the black ink composition and the light black ink composition. Note that because the pigment content is lower in the light black ink composition than in the black ink composition, a corresponding amount of a wetting agent, water or the like is added to the light black ink composition.

Moreover, the ink set of the present invention may further comprise a cyan ink composition containing a cyan pigment, and a light cyan ink composition containing the cyan pigment at a concentration less than the pigment concentration in the cyan ink composition.

In this case, it is preferable for the ratio of the pigment concentration in the cyan ink composition to the pigment concentration in the light cyan ink composition to be in a range of 2 to 5, this being from the perspective of further suppressing worsening of the graininess.

The content of the cyan pigment in the cyan ink composition is preferably in a range of 0.1 to 20 wt %, more preferably 1 to 10 wt %, of the cyan ink composition. On the other hand, the content of the cyan pigment in the light cyan ink composition is preferably in a range of 0.02 to 10 wt %, more preferably 0.2 to 5 wt %, of the light cyan ink composition. Use of the cyan pigment is preferably adjusted within these content ranges such that the ratio of the pigment concentration in the cyan ink composition to the pigment concentration in the light cyan ink composition is within the above-mentioned range.

Examples of cyan pigments that can be used in each of the cyan ink composition and the light cyan ink composition include C.I. Pigment Blues 1, 2, 3, 15 (Phthalocyanine Blue R), 15:1, 15:2, 15:3 (Phthalocyanine Blue G) 15:4, 15:6 (Phthalocyanine Blue E), 15:34, 16, 17:1, 22, 56, 60 and 63, and C.I. Vat Blues 4 and 60.

Of these, C.I. Pigment Blue 15:2 or 15:3 is preferable from the perspective of hue and colorability.

Moreover, the ink set of the present invention may further comprise a magenta ink composition containing a magenta pigment, and a light magenta ink composition containing the magenta pigment at a concentration less than the pigment concentration in the magenta ink composition.

In this case, it is preferable for the ratio of the pigment concentration in the magenta ink composition to the pigment concentration in the light magenta ink composition to be in a range of 2 to 7, this being from the perspective of further suppressing worsening of the graininess.

The content of the magenta pigment in the magenta ink composition is preferably in a range of 0.1 to 20 wt %, more preferably 1 to 10 wt %, of the magenta ink composition. On the other hand, the content of the magenta pigment in the light magenta ink composition is preferably in a range of 0.01 to 10 wt %, more preferably 0.2 to 5 wt %, of the light magenta ink composition. Use of the magenta pigment is preferably adjusted within these content ranges such that the ratio of the pigment concentration in the magenta ink composition to the pigment concentration in the light magenta ink composition is within the above-mentioned range.

Examples of magenta pigments that can be used in each of the magenta ink composition and the light magenta ink composition include C.I. Pigment Reds 1, 2, 3, 5, 7, 12, 17, 22 (Brilliant Fast Scarlet), 23, 31, 38,48 (Ca), 48 (Mn), 48:2 (Permanent red 2B (Ba)), 48:2 (Permanent Red 2B (Ca)), 48:3 (Permanent Red 2B (Sr)), 48:4 (Permanent Red 2B (Mn)), 49:1, 52:2, 53:1, 57 (Ca), 57:1 (Brilliant Carmine 6B), 60:1, 63:1, 63:2, 64:1, 81 (Rhodamine 6G lake), 83, 88, 101 (red iron oxide), 104, 105, 106, 108 (Cadmium Red), 112, 114, 122 (Quinacridone Magenta), 123, 144, 146, 149, 166, 168, 170, 172, 177, 178, 179, 184, 185, 190, 193, 202, 209, 219 and 264, and C.I. Pigment Violets 19 and 42.

Of these, C.I. Pigment Red 122, 123 or 144 is preferable from the perspective of hue and colorability.

Moreover, the ink set of the present invention may further comprise a yellow ink composition containing a yellow pigment.

Examples of yellow pigments that can be used in the yellow ink composition include C.I. Pigment Yellows 1 (Fast Yellow G), 2, 3, 12 (Disazo Yellow AAA), 13, 14, 16, 17, 24, 34, 35, 37, 42 (yellow iron oxide), 53, 55, 73, 74, 75, 81, 83 (Disazo Yellow HR), 93, 95, 97, 98, 100, 101, 104, 108, 109, 110, 114, 117, 120, 128, 129, 138, 151, 153, 154 and 155.

Of these, C.I. Pigment Yellow 74, 110 or 128 is preferable from the perspective of hue and colorability.

The content of the yellow pigment in the yellow ink composition is preferably in a range of 0.1 to 20 wt %, more preferably to 10 wt %, of the yellow ink composition.

It is preferable for the ink set of the present invention to be a 7-color ink set comprising the black ink composition and the light black ink composition, along with the cyan ink composition, the light cyan ink composition, the magenta ink composition, the light magenta ink composition and the yellow ink composition. However, so long as the ink set of the present invention contains at least the black ink composition and the light black ink composition, there are no particular limitations on the number of ink compositions; in addition to the above-mentioned 7-color ink set, the form of the ink set of the present invention can be made to be any of various other ones, for example a 5-color ink set comprising the black ink composition, the light black ink composition, the cyan ink composition, the magenta ink composition and the yellow ink composition.

The black ink composition and the light black ink composition in the ink set of the present invention, and other ink compositions that are used as necessary such as the cyan ink composition, the light cyan ink composition, the magenta ink composition, the light magenta ink composition and the yellow ink composition, each preferably contains penetrant(s) and water in addition to the pigment. The water used here is preferably pure water.

In the present invention, if penetrant (s) is/are used, then ability to penetrate into a recording medium can be given to the ink composition; moreover, by suitably adjusting the type of the penetrant(s) and the amount of the penetrant(s) added to the ink composition, the penetrability can be controlled. As a penetrant, it is particularly preferable to use a glycol ether or a 1,2-alkanediol, this being from the perspective of reducing the surface tension of the ink composition and thus increasing the ability of the ink composition to penetrate into a recording medium, whereby images of higher image quality can be obtained.

Here, preferable glycol ethers are ones selected from monoalkyl and monoaryl ether compounds of glycols such as mono- and poly-ethylene glycols and mono- and poly-propylene glycols. In particular, ones selected from compounds represented by undermentioned formula (I) are preferable.

R—O—[CₓH₂ₓ—O]_{y}—H (I)

(In the formula, R is an alkyl group having 1 to 6 carbon atoms, a phenyl group or a benzyl group, preferably a methyl group, an ethyl group, a propyl group or a butyl group; x is 1 to 3, preferably 2 or 3; and y is 1 to 8, preferably 1 to 5, more preferably 1 to 3.)

Specific examples of glycol ethers include ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol monomethyl ether, dipropylene glycol monoethyl ether, dipropylene glycol mono-n-propyl ether, and dipropylene glycol mono-iso-propyl ether.

Moreover, preferable 1,2-alkanediols are 1,2-alkanediols having 4 to 8 carbon atoms such as 1,2-butanediol, 1,2-pentanediol, 1,2-hexanediol, 1,2-heptanediol and 1,2-octanediol. Particularly preferable are 1,2-hexanediol, 1,2-heptanediol and 1,2-octanediol, which have 6 to 8 carbon atoms; using these is preferable since the ink composition can be given good ability to penetrate into a recording medium.

Moreover, a low-boiling-point water-soluble organic solvent such as a lower monohydric alcohol having 1 to 5 carbon atoms may also be used as a penetrant.

The above penetrants may be used singly, or a plurality selected either from within the same group or from different groups may be used mixed together. Moreover, it is preferable to use the penetrant(s) together with surfactant(s), described later, since then good penetration promotion and discharge stability, and thus good images can be obtained.

Moreover, out of the humectants that will be described later, ones that make the surface tension of the ink relatively low can be used as penetrants. In this case, for example propylene glycol, 1,6-hexanediol, 1,2,6-hexanetriol, trimethylol propane, N-methyl-2-pyrrolidone, urea, thiourea, 1,3-dimethylimidazolidinone and so on, which are included under humectants can be used as penetrants.

The content of the penetrant(s) in each of the ink compositions may be decided as appropriate in accordance with the desired penetrability, but is preferably in a range of 0.25 to 20 wt %, more preferably 1 to 15 wt %, of the ink composition.

It is preferable for each of the ink compositions in the ink set of the present invention to further contain surfactant (s), this being from the perspective of reducing the surface tension of the ink composition, whereby the image quality can be improved.

From the perspective of being able to secure the discharge stability of the ink composition, it is preferable to use an acetylene glycol or a polyorganosiloxane as a surfactant.

Here, preferable examples of acetylene glycols are compounds represented by undermentioned formula (II).

[image]

(In the formula, 0≦m+n≦50, and R¹, R², R³ and R⁴ each independently represents an alkyl group (preferably an alkyl group having 1 to 6 carbon atoms).)

Out of the compounds represented by above-mentioned formula (II), examples of particularly preferable ones include 2,4,7,9-tetramethyl-5-decyne-4,7-diol, 3,6-diemthyl-4-octyne-3,6-diol, and 3,5-diemthyl-1-hexyne-3-ol. As acetylene glycols represented by above-mentioned formula (II), commercially sold ones can be used; specific examples include Surfinol 61, 82, 104, 440, 465, 485 and TG (all available from Air Products and Chemicals Inc.), and Olfine Y, E1010 and STG (all made by Nissin Chemical Industry Co., Ltd.).

Moreover, preferable examples of polyorganosiloxanes are polyether-modified polysiloxanes, in particular compounds represented by undermentioned formula (III).

[image]

(In the formula, R¹ to R⁷ each independently represents an alkyl group having 1to 6carbon atoms; j and k each independently represents an integer from 1 upwards; EO represents an ethyleneoxy group; PO represents a propyleneoxy group; m and n each represents an integer from 0 upwards, with the proviso that m+n represents an integer from 1 upwards; and in the square brackets there is no limitation on the order of the EO's and PO's, with a random order or blocks possible.

Preferable examples of such compounds include commercially sold ones such as ‘BYK-345’, ‘BYK-346’, ‘BYK-341’ and ‘BYK-348’ (all made by BYK Chemie Japan).

The above surfactants may be used singly, or a plurality selected either from within the same group or from different groups may be used mixed together.

The content of the surfactant(s) in each of the ink compositions may be decided as appropriate in accordance with the desired penetrability, but is preferably in a range of 0.01 to 5 wt %, more preferably 0.1 to 2 wt %, of the ink composition.

Each of the ink compositions in the ink set of the present invention may further contain humectant(s). If humectant(s) is/are used, then drying up of the ink can be suppressed, and hence in the case of using in an ink jet printer, evaporation of moisture due to drying at the nozzle tips in the printer head can be suppressed, and thus coagulation/solidification of the ink can be prevented.

It is preferable for the humectant(s) to be selected from materials that are water-soluble and are highly hygroscopic; examples are glycerol, ethylene glycol, diethylene glycol, triethylene glycol, tetraethylene glycol, and other polyethylene glycols, propylene glycol, dipropylene glycol, and other polypropylene glycols, 1,3-propanediol, 1,4-butanediol, 1,5-pentanediol, 1,6-hexanediol, polyols containing three or more hydroxyl groups such as 1,2,6-hexanetriol, trimethylol ethane, trimethylol propane, and pentaerythritol, lactams such as 2-pyrrolidone, N-methyl-2-pyrrolidone, and ε-caprolactam, and urea type compounds such as urea itself, thiourea, ethylene urea, and 1,3-dimethylimidazolidinone. Of these, polyols such as glycerol, ethylene glycol, and mixtures thereof are particularly preferable, this being from the perspective of being able to improve the effects.

Moreover, it is also possible to use saccharides, for example sugar alcohols such as maltitol and sorbit, and derivatives thereof as humectants.

The content of the humectant(s) in each of the ink compositions is preferably 1 to 50 wt %, more preferably 5 to 40 wt %, of the ink composition.

In addition, pH regulators, preservatives, fungicides, dissolution assistants, antioxidants, ultraviolet absorbers, and so on can also be included as necessary in each of the ink compositions in the ink set of the present invention.

With the ink set of the present invention, it is preferable for each of the ink compositions to be a water-based ink composition that contains penetrant(s), surfactant(s), wetting agent(s) and water (preferably pure water) in addition to the pigment. When preparing an ink composition as such a water-based ink composition, the ink composition may be prepared by first preparing a pigment dispersion obtained by dispersing the pigment in an aqueous medium using dispersant(s), and then adding the penetrant(s), the surfactant(s), the wetting agent(s), and if necessary other components to the pigment dispersion.

The dispersion of the pigment using the dispersant(s) is carried out by dispersing the pigment, the aqueous medium and the dispersant(s), described below, in a suitable disperser such as a ball mill, a sand mill, an attritor, a roll mill, an agitator mill, a Henschel mixer, a colloid mill, an ultrasonic homogenizer, a jet mill, or an Angmill. Note that the penetrant(s), the surfactant(s), the wetting agent(s), and if necessary other components may be added when preparing the pigment dispersion.

As dispersants, ones that are suitable for preparing pigment dispersions are good, with synthetic polymers being preferable examples; examples are polyvinyl alcohols, polyvinyl pyrrolidones, acrylic resins such as polyacrylic acid, acrylic acid-acrylonitrile copolymers, potassium acrylate-acrylonitrile copolymers, vinyl acetate-acrylic acid ester copolymers, and acrylic acid-acrylic acid ester copolymers, styrene-acrylic resins such as styrene-acrylic acid copolymers, styrene-methacrylic acid copolymers, styrene-methacrylic acid-acrylic acid ester copolymers, styrene-α-methylstyrene-acrylic acid copolymers, and styrene-α-methylstyrene-acrylic acid-acrylic acid ester copolymers, styrene-maleic acid copolymers styrene-maleic anhydride copolymers, vinylnaphthalene-acrylic acid copolymers, vinylnaphthalene-maleic acid copolymers, and vinyl acetate type copolymers such as vinyl acetate-ethylene copolymers, vinyl acetate-fatty acid vinyl ethylene copolymers, vinyl acetate-maleic acid ester copolymers, vinyl acetate-crotonic acid copolymers, and vinyl acetate-acrylic acid copolymers, and salts thereof. These can be used singly, or two or more can be used mixed together.

Of these synthetic polymers, in particular copolymers between monomers having hydrophobic groups and monomers having hydrophilic groups, and polymers of monomers having both hydrophobic groups and hydrophilic groups in the molecular structure thereof are preferable. Note that with copolymers, there are no particular limitations on the form thereof, for example random copolymers or block copolymers.

Moreover, examples of the above-mentioned salts are salts with diethylamine, ammonia, ethylamine, triethylamine, propylamine, isopropylamine, dipropylamine, butylamine, isobutylaminet triethanolamine, diethanolamine, aminomethylpropanol, morpholine, and so on.

These synthetic polymers preferably have a weight average molecular weight in a range of 1,000 to 50,000,-more preferably 3,000 to 15,000. Moreover, the synthetic polymers preferably have an acid value in a range of 50 to 300, more preferably 70 to 150. Moreover, the synthetic polymers are manufactured using a publicly-known polymerization method such as radical copolymerization or group transfer polymerization.

In the present invention, particularly preferable dispersants are styrene-(meth) acrylic acid copolymers and salts thereof, this being from the perspective of dispersion stability and so on ‘Styrene-(meth)acrylic acid copolymers and salts thereof’ basically refers to compounds that have in the structure thereof at least a styrene framework and a (meth)acrylic acid framework, and may have in the structure thereof a framework derived from a monomer having another unsaturated group, for example a (meth)acrylic acid ester framework. Regarding the form of the copolymer, the manufacturing method, the acid value and the weight average molecular weight for these styrene-(meth) acrylic acid copolymers and salts thereof, preferable ones are as mentioned above for synthetic polymers.

Moreover, in addition to the synthetic polymers described above, natural polymers can be used as dispersants. Moreover, the dispersant(s) can be used added to water in the form of an emulsion or the like, and in this case commercially sold ones such as the Joncryl series made by Johnson Polymer Co. can be used.

The amount used of the dispersant(s) is preferably in a range of 5 to 300 parts by weight, more preferably 10 to 200 parts by weight, per 100 parts by weight of the pigment.

Moreover, examples of aqueous media that can be used for preparing the pigment dispersion are water, organic solvents, and mixtures of water and organic solvents. The water used here is preferably pure water, and examples of organic solvents include, for example, monohydric alcohols such as methanol, ethanol, n-propyl alcohol, iso-propyl alcohol, n-butanol, sec-butanol, tert-butanol, iso-butanol, and n-pentanol, polyhydric alcohols such as ethylene glycol, diethylene glycol, triethylene glycol, polyethylene glycol, polypropylene glycol, propylene glycol, butylene glycol, 1,2,6-hexanetriol, thioglycol, hexylene glycolf trimethylol ethane, and trimethylol propane, polyhydric alcohol alkyl ethers such as ethylene glycol monoethyl ether, ethylene glycol monobutyl ether, diethylene glycol ionomethyl ether, diethylene glycol monoethyl ether, diethylene glycol monobutyl ether, triethylene glycol monomethyl ether, triethylene glycol monoethyl ether, and triethylene glycol monobutyl ether, urea, 2-pyrrolidone, N-methyl-2-pyrrolidone, 1,3-dimethyl-2-imidazolidinone, and triethanolamine. These organic solvents can be used singly, or two or more can be used mixed together.

There are no particular limitations on the usage of the ink set of the present invention, but from the perspective of it being possible to print high-resolution, high-quality images at high speed using a relatively inexpensive apparatus, the ink set is preferably used in the so-called ink jet recording method as recording liquids that are discharged as droplets from the printer head of an ink jet printer to form images such as diagrams or characters on a recording medium such as paper.

(Recording method)

According to the present invention, a recording method in which an image is formed on a recording medium using an ink set as described above is provided. One embodiment of the recording method of the present invention is an ink jet recording method in which printing is carried out by discharging droplets of the ink compositions in the ink set and attaching these droplets onto a recording medium.

By implementing the recording method of the present invention, because an ink set as described above for which the black pigment concentration ratio is within a prescribed range is used, color differences of a recorded image due to differences in light source can be made to be slight, and the color reproduction range in dark parts of an image can be broadened, while maintaining high image quality with no worsening of the graininess in the dark parts.

(Recorded article)

According to the present invention, a recorded article comprising a recording medium having an image formed thereon using an ink set as described above is provided. Because the recorded article of the present invention is obtained using an ink set as described above for which the black pigment concentration ratio is within a prescribed range, the recorded article has a high-quality image for which color differences due to differences in light source are slight, the graininess in dark parts is good, and the color reproduction range in the dark parts is broadened.

### EXAMPLES

Next, the present invention will be described in a more concrete fashion through examples and comparative examples; however, the present invention is not limited whatsoever by these examples. Note that, unless stated otherwise, ‘%’ and ‘parts’ mean ‘wt %’ and ‘parts by weight’ respectively.

[Preparation of pigment dispersions]

100 parts of a pigment was mixed with 20 parts of a styrene-acrylate copolymer resin (acid value 100, weight average molecular weight 10,000), and then a mixed liquid was obtained by making up with pure water such that the concentration of the dispersed pigment became 25%. This mixed liquid was subjected to dispersion in a sand mill (made by Yasukawa Seisakusho) with zirconia beads, and then the beads were removed, thus obtaining a pigment dispersion. The pigment dispersion obtained was given a name as follows in accordance with the pigment used.

Pigment dispersion Sk: Carbon black (Color Black S170 made by Degussa)

Pigment dispersion Y: C.I. Pigment Yellow 74

Pigment dispersion M: C.I. Pigment Red 122

Pigment dispersion C: C.I. Pigment Blue 15:3

[Preparation of ink compositions]

A pigment dispersion obtained as described above was mixed with the components shown in Table 1 below, and stirring was carried out for 60 minutes at 25° C. The mixed liquid obtained was filtered using an 8 μm membrane filter, thus obtaining an ink composition. The contents (units: wt %) of the various components in each of the ink compositions are shown in Table 1. Note that the amounts shown in the pigment dispersion rows in Table 1 indicate the amounts of the pigments.

TABLE 1

| | Bk 1 | Bk 2 | Lk 1 | Lk 2 | Lk 3 | Lk 4 | Lk 5 | Y 1 | Y 2 | M 1 | M 2 | Lm 1 | Lm 2 | C 1 | C 2 | Lc 1 | Lc 2 |
|---|---|---|---|---|---|---|---|---|---|---|---|---|---|---|---|---|---|
| Pigment dispersion Bk | 2.5 | 2.5 | 1.25 | 0.8 | 0.63 | 0.5 | 0.85 | — | — | — | — | — | — | — | — | — | — |
| | | | | 5 | | | | | | | | | | | | | |
| Pigment dispersion Y | — | — | — | — | — | — | — | 5 | 5 | — | — | — | — | — | — | — | — |
| Pigment dispersion M | — | — | — | — | — | — | — | — | — | 6 | 6 | 1 | 1 | — | — | — | — |
| Pigment dispersion C | — | — | — | — | — | — | — | — | — | — | — | — | — | 4 | 4 | 1 | 1 |
| Glycerol | 20 | 20 | 20 | 20 | 20 | 20 | 20 | 14 | 14 | 17 | 17 | 18 | 18 | 19 | 19 | 19 | 19 |
| Ethylene glycol | — | — | 5 | 5 | 5 | 5 | 5 | — | — | — | — | 9 | 9 | — | — | 9 | 9 |
| 1,2-hexanediol | 5 | — | 5.2 | 5.2 | 5.2 | 5.2 | — | 5 | — | 4 | — | 5 | — | 5 | — | 5 | — |
| BYK-348 | 0.5 | — | 0.5 | 0.5 | 0.5 | 0.5 | — | 0.5 | — | 0.4 | — | 0.5 | — | 0.5 | — | 0.5 | — |
| Triethylene glycol | — | 10 | — | — | — | — | 7 | — | 5 | — | 5 | — | 5 | — | 5 | — | 5 |
| monobutyl ether | | | | | | | | | | | | | | | | | |
| Olfine E1010 | — | 1 | — | — | — | — | 0.5 | — | 1 | — | 0.6 | — | 1 | — | 1 | — | 1 |
| Triethanolamine | 0.9 | 0.9 | 0.9 | 0.9 | 0.9 | 0.9 | 0.9 | 0.9 | 0.9 | 0.9 | 0.9 | 0.9 | 0.9 | 0.9 | 0.9 | 0.9 | 0.9 |
| Pure water | Re- | Re- | Re- | Re- | Re- | Re- | Re- | Re- | Re- | Re- | Re- | Re- | Re- | Re- | Re- | Re- | Re- |
| | main- | main- | main- | main- | main- | main- | main- | main- | main- | main- | main- | main- | main- | main- | main- | main- | main- |
| | der | der | der | der | der | der | der | der | der | der | der | der | der | der | der | der | der |

### Example 1

Out of the ink compositions shown in Table 1,the 7-color combination consisting of Bk1, Lk1, Y1, C1, Lc1, M1 and Lm1 was taken as Ink Set 1.

### Example 2

The 7-color combination consisting of Ink Set 1 of Example 1 but with the light black ink composition changed to Lk2 was taken as Ink Set 2.

### Example 3

The 7-color combination consisting of Ink Set 1 of Example 1 but with the light black ink composition changed to Lk3 was taken as Ink Set 3.

### Example 4

Out of the ink compositions shown in Table 1,the 7-color combination consisting of Bk2, Lk5, Y2, C2, Lc2, M2 and Lm2 was taken as Ink Set 4.

### Comparative Example 1

The 7-color combination consisting of Ink Set 1 of Example 1 but with the light black ink composition changed to Lk4 was taken as Ink Set 5.

### Comparative Example 2

The 6-color combination consisting of Ink Set 1 of Example 1 but with the light black ink composition omitted was taken as Ink Set 6.

Following is a summary of the combination of ink compositions constituting the ink set of each of the examples.

Ink set 1: Y1, C1, Lc1, M1, Lm1, Bk1, Lk1 (7 colors)

Ink set 2: Y1, C1, Lc1,M1, Lm1, Bk1, Lk2 (7 colors)

Ink set 3: Y1, C1, Lc1, M1, Lm1, Bk1, Lk3 (7 colors)

Ink set 4: Y2, C2, Lc2, M2, Lm2, Bk2, Lk5 (7 colors)

Ink set 5: Y1, C1, Lc1, M1 , Lm1, Bk1, Lk4 (7 colors)

Ink set 6: Y1, C1, Lc1, M1 , Lm1, Bk1 (6 colors)

Evaluation tests]

The following evaluation tests were carried out by filling each of the above-mentioned Ink Sets 1 to 6 into a PM-950C ink jet printer (made by Seiko Epson Corporation), and carrying out printing on MC photographic paper (made by Seiko Epson Corporation). The results obtained are shown in Table 2.

(1) Evaluation of color difference between light sources

A gray gradated pattern having 80 equal divisions from white to black was printed, color measurements were taken with each of a D50 light source and an A Light source to determine L*, a* and be for each of the 80 divisions, and the color difference ΔE between the light sources was determined for each of the 80 divisions from undermentioned equation (1). Note that an SPM-50 colorimeter (made by Gretag) was used for the color measurements on the printed articles.

ΔE={(L*_{D5O}−L*_{A})²+(a*_{D5O}−a*_{A})²+(b*_{D5O}−b*_{A})²}^{1/2} (1)

The color difference was evaluated from the maximum of the values obtained over the 80 divisions according to the following criteria.

Evaluation A: Less than 2

Evaluation B: At least 2, but less than 5

Evaluation C: At least 5

(2) Evaluation of graininess

Gradated patterns from various hues (red, green, blue, cyan, magenta and yellow) to black were printed.

Then, each of the printed patterns was scanned under the following conditions.

Scanner: DT-S1045A1 (made by Dainippon Screen Mfg- Co., Ltd.)

Resolution: 1300 dpi

Region targeted for analysis: 512×512 pixels (10×10 mm)

Next, the scanned image data was transformed into L*a*b* space, a 2-D FFT (two-dimensional fast Fourier transform) was carried out on the L* component image, and then the image was made into a 1-D image by transforming into polar coordinates, and the Wiener spectrum Ws (u) of the image was obtained. This was done with reference to ‘Half-tone color image noise evaluation method’ by Imagawa et al. (Collected Papers from Hardcopy '96, pages 189-192, 1996)

Moreover, VTF(u), which shows the visual spatial frequency characteristic, was calculated using undermentioned equation (2), with the least distance of distinct vision 1 assumed to be 300 mm.

VTF(u)=5.05exp(−0.138πlu/180){1−exp(−0.1πlu/180)} (2)

Finally, the graininess index was calculated from WS (u) and VTF(u) using undermentioned equation (3), and the graininess for each case was evaluated.

Graininess index=a(L*)∫(WS(u))^{0.5}VTF(u)du (3)

Here, undermentioned equation (4) was used for a (L*), which is for lightness correction, in above-mentioned equation (3). The above is simple, with only the L* component being used, but is original, with a good correlation with a high correlation coefficient of 0.95 being obtained between subjective evaluation results using 8 types of ink jet printer and Pictrography gray patches of 9 lightness levels.

a(L*)=((L*+16)/116)^{0.8} (4)

The graininess index was determined for each of the printed patterns of the examples as described above, and the value of the graininess index was calculated for when the value for Ink Set 6 was taken as 1.0. Evaluation was carried out based on the value obtained according to the following criteria. Note that the L*=30 part of the gradated pattern was used as the comparison point. The smaller the value of the graininess index, the lower the graininess of the formed image, i.e. the higher the image quality.

Evaluation A: Less than 0.7

Evaluation 8: At least 0.7, but less than 1.0

Evaluation C: At least 1.0

(3) Evaluation of color reproduction ability

Patch patterns containing various hues having the same prescribed L* value were printed using each of Ink Sets 1 to 6, color measurements were carried out to determine a* and b*, and the color reproduction range at each of the prescribed L* values was determined. Note that an SPM-50 colorimeter (made by Gretag) was used for the color measurements on the printed articles.

Specifically, the value of the color reproduction area (a*×b*) was calculated in the evaluated L* values to be 30, 40 and 50 respectively for each of Ink Sets on the basis that the value of (a*×b*) in L*=30, 40, 50 respectively for Ink Set 6 being taken as 100%, and the color reproduction ability was evaluated from the results obtained according to the following criteria.

Evaluation A: More than 105%

Evaluation B: More than 100%, but not more than 105%

Evaluation C: 100% or less

TABLE 2

| | | Ink | Ink | Ink | Ink | Ink | Ink |
|---|---|---|---|---|---|---|---|
| | | set 1 | set 2 | set 3 | set 4 | set 5 | set 6 |
| Evaluation of color difference | | A | A | A | A | A | C |
| between light sources | | | | | | | |
| Evaluation of | Red | A | A | A | A | A | C |
| graininess | Green | A | A | A | A | A | C |
| | Blue | B | B | B | B | B | C |
| | Cyan | A | A | A | A | A | C |
| | Magenta | A | A | A | A | A | C |
| | Yellow | B | B | B | B | B | C |
| Evaluation of | L* = 30 | A | A | A | A | C | C |
| color | L* = 4O | A | A | B | A | C | C |
| reproduction | L* = 5O | B | B | B | B | B | C |
| ability | | | | | | | |

According to the present invention, there are provided an ink set and a recording method for which color differences of a recorded image due to differences in light source can be made to be slight, and the color reproduction range in dark parts of an image can be broadened, while maintaining high image quality with no worsening of the graininess in the dark parts. Moreover, according to the present invention, there is provided a recorded article that has a high-quality image for which color differences due to differences in light source are slight, the graininess in dark parts is good, and the color reproduction range in the dark parts is broadened.

What is claimed is:

1. An ink set, comprising at least a black ink composition containing a black pigment, and a light black ink composition containing the black pigment at a concentration less than the pigment concentration in said black ink composition;
wherein the ratio of the pigment concentration in said black ink composition to the pigment concentration in said light black ink composition is in a range of 2 to 4.5.

2. The ink set according to claim 1, wherein said black pigment is carbon black.

3. The ink set according to claim 1 or 2, further comprising a cyan ink composition containing a cyan pigment, and a light cyan ink composition containing the cyan pigment at a concentration less than the pigment concentration in said cyan ink composition.

4. The ink set according to claim 3, wherein the ratio of the pigment concentration in said cyan ink composition to the pigment concentration in said light cyan ink composition is in a range of 2 to 5.

5. The ink set according to claim 3 or 4, wherein said cyan pigment is C.I. Pigment Blue 15:2 or 15:3.

6. The ink set according to any of claims 1 through 5, further comprising a magenta ink composition containing a magenta pigment, and a light magenta ink composition containing the magenta pigment at a concentration less than the pigment concentration in said magenta ink composition.

7. The ink set according to claim 6, wherein the ratio of the pigment concentration in said magenta ink composition to the pigment concentration in said light magenta ink composition is in a range of 2 to 7.

8. The ink set according to claim 6 or 7, wherein said magenta pigment is C.I Pigment Red 122, 123 or 144.

9. The ink set according to any of claims 1 through 8, further comprising a yellow ink composition containing a yellow pigment.

10. The ink set according to claim 9, wherein said yellow pigment is C.I. Pigment Yellow 74, 110 or 128.

11. The ink set according to any of claims 1 through 10, wherein the ink compositions in the ink set each contain a penetrant and water.

12. The ink set according to claim 11, wherein said penetrant is a glycol ether or a 1,2-alkanediol.

13. The ink set according to any of claims 1 through 12, wherein the ink compositions in the ink set each contain a surfactant.

14. The ink set according to claim 13, wherein said surfactant is an acetylene glycol or a polyorganosiloxane.

15. A recording method, comprising the step of forming an image on a recording medium using the ink set according to any of claims 1 through 14.

16. A recorded article, comprising a recording medium having an image formed thereon using the ink set according to any of claims 1 through 14.
